(19) United States
(12) Patent Application Publication
(10) Pub. No.: US 2025/0305524 A1
(43) Pub. Date: Oct. 2, 2025

(54) FIXING DEVICE FOR STORAGE BOX OF LOW-SPEED ELECTRIC VEHICLE

(71) Applicant: Xiamen Dalle New Energy Automobile Co.,Ltd, Xiamen City (CN)

(72) Inventor: Side Dai, Xiamen City (CN)

(21) Appl. No.: 18/662,634

(22) Filed: May 13, 2024

(30) Foreign Application Priority Data
Mar. 29, 2024 (CN) 202420637832.3

(51) Int. Cl. F16B 5/00; B60R 9/06

(52) U.S. Cl. CPC F16B 5/0092; B60R 9/065

(57) ABSTRACT

A fixing device for a storage box of a low-speed electric vehicle; wherein the storage box is configured to be arranged on a rear end of the low-speed electric vehicle. The fixing device includes a rotary seat detachably connected to the storage box, and a mounting portion is concavely formed on the low-speed electric vehicle. The rotary seat is configured to be rotatably assembled in the mounting portion. A mounting surface of the rotary seat is arranged with a convex rib, the convex rib being arranged with a clamping block, and a mounting gap is defined between a part of the clamping block and the convex rib. A resisting piece is convexly formed on the mounting portion, and the clamping block is clamped with or separated from the resisting piece when rotating with the rotary seat.

### CROSS REFERENCE

The present disclosure claims priority of Chinese Patent Application No. 2024206378323 filed on Mar. 29, 2024, the entire contents of which are hereby incorporated by reference in their entirety.

### TECHNICAL FIELD

The present disclosure relates to the technical field of electric vehicles, and more specifically to a fixing device for a storage box of a low-speed electric vehicle.

### BACKGROUND

Low-speed electric vehicles have various types, and correspondingly have various functions. Currently, electric cars in China are mainly used for sightseeing passengers, security patrols, handling of goods, etc. The main purpose of the electric sightseeing car is applied as a passenger carrier in parks, scenic spots, recreational resorts, universities, hospitals, golf courses, real estate companies, etc. The main purpose of the electric patrol car is applied to carry out security patrols in the station square and other crowded places. In the driving process, it is often required to place tools and items, etc., and since the space inside the vehicles are limited, rear storage box and other devices are widely used. However, in practice, the rear storage box is troublesome to dismantle, not easy to take care of, and easy to rust and damage.

### SUMMARY OF THE DISCLOSURE

The main purpose of the present disclosure is to provide a fixing device for a storage box of a low-speed electric vehicle, in order to solve the above problems raised in the related art.

In order to realize the above purpose, the present disclosure provides the following technical solutions: a fixing device for a storage box of a low-speed electric vehicle; wherein the storage box is configured to be arranged on a rear end of the low-speed electric vehicle; the fixing device includes a rotary seat detachably connected to the storage box, and a mounting portion is concavely formed on the low-speed electric vehicle; the rotary seat is configured to be rotatably assembled in the mounting portion; a mounting surface of the rotary seat is arranged with a convex rib, the convex rib being arranged with a clamping block, and a mounting gap is defined between a part of the clamping block and the convex rib; a resisting piece is convexly formed on the mounting portion, and the clamping block is clamped with or separated from the resisting piece when rotating with the rotary seat.

In some embodiments, a thickness of the resisting piece is equal to or less than a thickness of the mounting gap.

In some embodiments, the convex rib includes two convex ribs, and a positive projection of the two convex ribs in a plane where the rotary seat is located is in a shape of a Taiji; the resisting piece includes two resisting pieces, and the two resisting pieces are symmetrically arranged on an inner wall of the mounting portion.

In some embodiments, the clamping block includes two clamping blocks, and each of the two clamping blocks is disposed at an end of a corresponding convex rib; each clamping block is in a curved structure.

In some embodiments, a column is convexly formed on a middle part of the mounting portion, and the column has a sliding surface; the column is capable of cooperating with a rotation movement of the clamping block when the clamping block rotates with the rotary seat.

In some embodiments, an operating surface of the rotary seat defines a countersunk hole, and a rotation block is arranged in the countersunk hole.

In some embodiments, the rotation block is S-shaped.

In some embodiments, the fixing device further includes a fixing seat; the fixing seat is arranged on the low-speed electric vehicle and coaxially disposed with the rotary seat, and a connecting mechanism is arranged between the fixing seat and the rotary seat.

In some embodiments, the connecting mechanism includes a bump arranged on the rotary seat and a clamping slot defined on the fixing seat.

Compared to the related art, the beneficial effect of the present disclosure is that: the present disclosure proposes a simple structure, such that it is easy to mount or dismantle the storage box through the cooperation of the clamping block and the resisting piece, which is convenient for storage and cleaning.

### BRIEF DESCRIPTION OF THE DRAWINGS

FIG. 1 is a structural schematic view of a rotary seat for a storage box of a low-speed electric vehicle according to some embodiments of the present disclosure.

FIG. 2 is a structural schematic view of a rotary seat for a storage box of a low-speed electric vehicle according to some embodiments of the present disclosure at another viewing angle.

FIG. 3 is a structural schematic view of a mounting portion for a storage box of a low-speed electric vehicle according to some embodiments of the present disclosure.

FIG. 4 is a structural schematic view of a low-speed electric vehicle arranged with a storage box according to some embodiments of the present disclosure.

FIG. 5 is a structural schematic view of a low-speed electric vehicle disassembled with a storage box according to some embodiments of the present disclosure.

FIG. 6 is a structural schematic view of a rotary seat for a storage box of a low-speed electric vehicle according to other embodiments of the present disclosure.

FIG. 7 is a structural schematic view of a mounting portion for a storage box of a low-speed electric vehicle according to other embodiments of the present disclosure.

In the drawings: 100—storage box, 1—rotary seat, 11—convex rib, 12—clamping block, 13—mounting gap, 14—countersunk hole, 15—rotation block, 2—mounting portion, 21—resisting piece, 22—column, 221—sliding surface, 3—fixing seat, 41—bump, 42—clamping slot.

### DETAILED DESCRIPTION

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained by those skilled in the art without making creative labor fall within the scope of the present disclosure.

### Implementation I

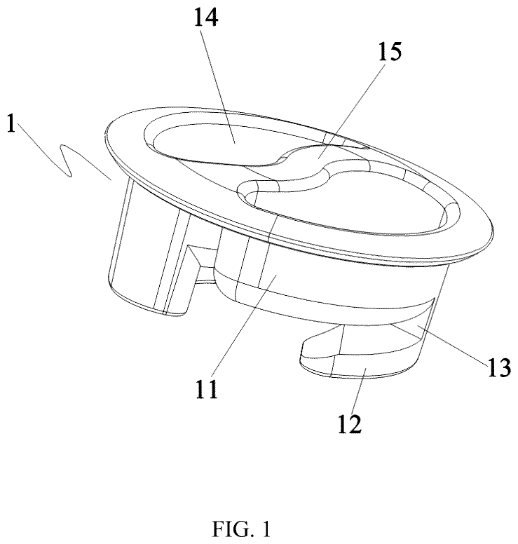

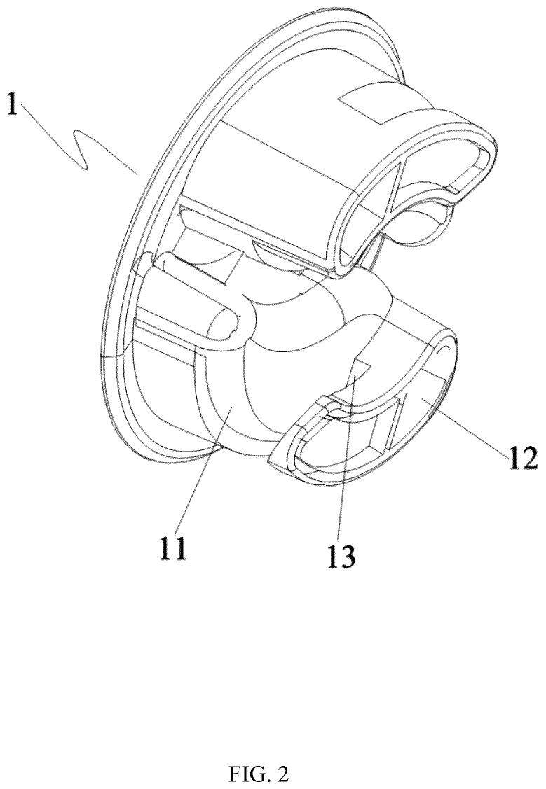

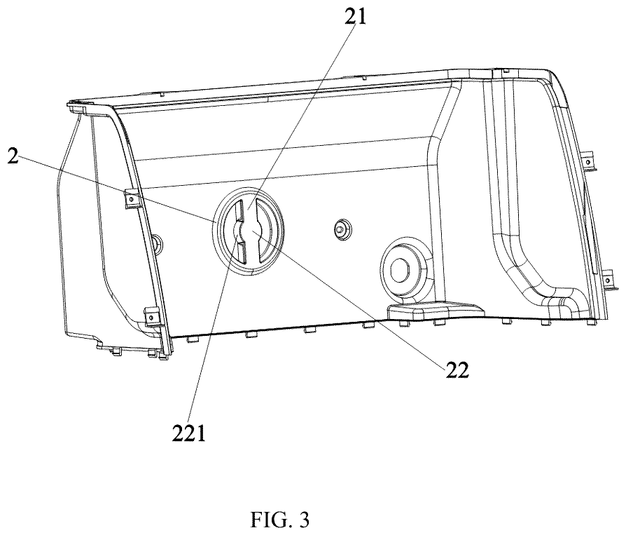

As shown in FIGS. 1 to 3, the present embodiments provide a fixing device for a storage box of a low-speed electric vehicle; the storage box 100 is to be arranged on a rear end of the low-speed electric vehicle; the fixing device includes a rotary seat 1 detachably connected to the storage box 100, and the storage box 100 defines a through hole adapted to the rotary seat 1 for the rotary seat 1 to pass through; a mounting portion 2 is concavely formed on the low-speed electric vehicle, and the rotary seat 1 and the mounting portion 2 are both circular in shape; the rotary seat 1 is to be rotatably assembled in the mounting portion 2; a mounting surface of the rotary seat 1 is arranged with a convex rib 11, the convex rib 11 being arranged with a clamping block 12, and a mounting gap 13 is defined between a part of the clamping block 12 and the convex rib 11; a resisting piece 21 is convexly formed on the mounting portion 2, and the resisting piece 21 has a thickness equal to or less than a thickness of the mounting gap 13; the clamping block 12 is clamped with or separated from the resisting piece 21 when rotating with the rotary seat 1; in some embodiments, the thickness of the resisting piece 21 is slightly less than the thickness of the mounting gap 13; the convex rib 11 includes two convex ribs 11, and a positive projection of the two convex ribs 11 in a plane where the rotary seat 1 is located is in a shape of a Taiji; the clamping block 12 includes two clamping blocks 12, and each of the two clamping blocks 12 is disposed at an end of a corresponding convex rib 11; each clamping block 12 is in a curved structure; the resisting piece 21 includes two resisting pieces 21, and the two resisting pieces 21 are symmetrically arranged on an inner wall of the mounting portion 2; a column 22 is convexly formed on a middle part of the mounting portion 2, and the column 22 has an end surface flush with the resisting piece 21; the column 22 further has a sliding surface 221; for example, the column 22 is cylindrical, cooperating with a rotation movement of the clamping block 12 when the clamping block 12 rotates with the rotary seat 1; an operating surface of the rotary seat 1 defines a countersunk hole 14, where a rotation block 15 is arranged in the countersunk hole 14, and the rotation block 15 is S-shaped, which is convenient for a finger to rotate.

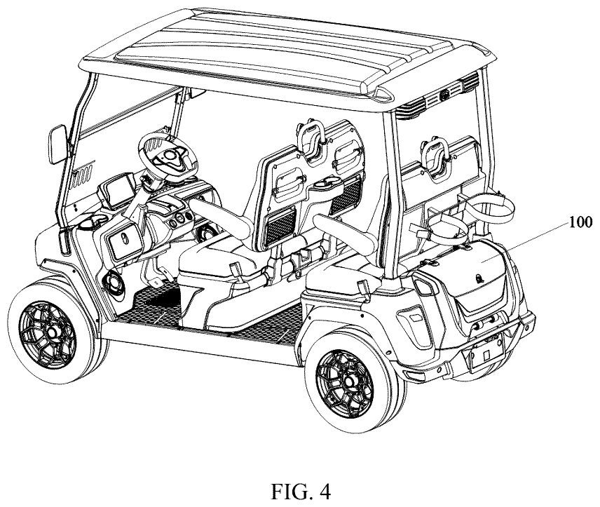

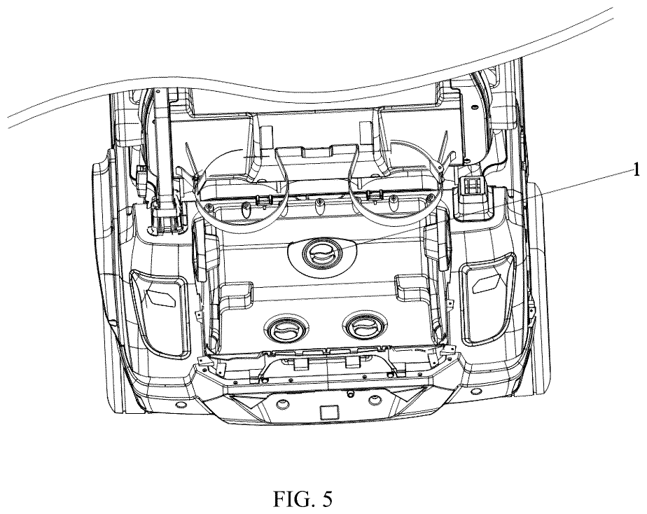

As shown in FIGS. 4 to 5, the present embodiments further provide a low-speed electric vehicle including the above-described fixing device for a storage box of a low-speed electric vehicle, where the storage box 100 is to be mounted on a rear end of the low-speed electric vehicle. The low-speed electric vehicle includes one or more of a sightseeing car, a golf cart, a fire truck, and a patrol car. The fixing device may include one or more fixing devices, such that the storage box 100 and the low-speed electric vehicle are stably fixed. When it is necessary to mount the storage box 100, the rotary seat 1 is passed through the through hole of the storage box 100 and extended into the mounting portion 2; the rotary seat 1 is rotated by holding the rotation block 15 with two fingers, such that the convex rib 11 and the clamping block 12 rotate together, and the column 22 cooperates with the rotation movement of the clamping block 12, until the clamping block 12 is clamped with the resisting piece 21, in which case the resisting piece 21 is located in the mounting gap 13 between the convex rib 11 and the clamping block 12. When it is necessary to dismantle the storage box 100, the rotary seat 1 is reversed, and the clamping block 12 is separated from the resisting piece 21, such that the storage box 100 can be dismantled.

### Implementation II

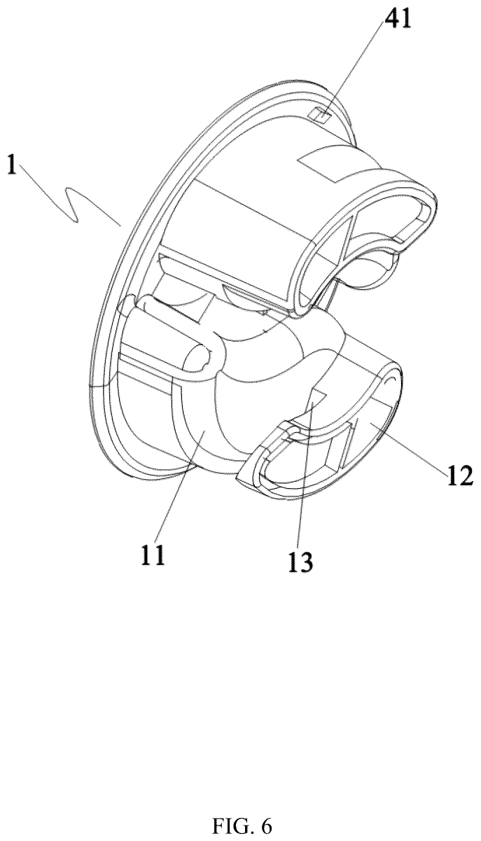

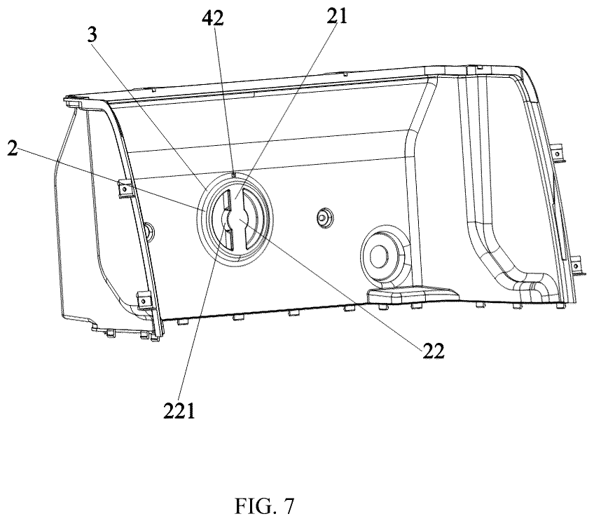

As shown in FIGS. 6 and 7, the fixing device of the present embodiments has the same rotary seat 1 and mounting portion 2 as those of the Implementation I. Different from the Implementation I, the fixing device further includes a fixing seat 3, the fixing seat 3 is arranged on the low-speed electric vehicle, e.g., fixed to the low-speed electric vehicle by bolt mounting. The fixing seat 3 is coaxially arranged with the rotary seat 1, and a connecting mechanism is arranged between the fixing seat 3 and the rotary seat 1, the connecting mechanism including a bump 41 arranged on the rotary seat 1 and a clamping slot 42 defined on the fixing seat 3; the bump 41 has an inclined surface. When it is necessary to mount the storage box 100, the rotary seat 1 is passed through the through hole of the storage box 100 and extended into the mounting portion 2; the rotary seat 1 is rotated with the rotation block 15 with two fingers, such that the bump 41, the convex rib 11, and the clamping block 12 are rotated together, and the column 22 cooperates with the rotation movement of the clamping block 12, until the bump 41 is stuck into the clamping slot 42, and the clamping block 12 is clamped with the resisting piece 21, in which case the resisting piece 21 is located in the mounting gap 13 between the convex rib 11 and the clamping block 12. Because the bump 41 is stuck into the clamping slot 42, the storage box 100 has a double fixation with the low-speed electric vehicle, which is more stable. When it is necessary to dismantle the storage box 100, the rotary seat 1 is reversed, the bump 41 is separated from the clamping slot 42, and the clamping block 12 is separated from the resisting piece 21, such that the storage box 100 can be dismantled.

The present disclosure proposes a simple structure, such that it is easy to mount or dismantle the storage box through the cooperation of the clamping block and the resisting piece, which is convenient for storage and cleaning.

Although the present disclosure has been described in detail with reference to the foregoing embodiments, for those skilled in the art, it is still possible to make modifications to the technical solutions recorded in the foregoing embodiments, or make equivalent replacements for some of the technical features therein. Any modifications, equivalent replacements, improvements, etc. made within the spirit and principles of the present disclosure shall be included in the scope of the present disclosure.

What is claimed is:

1. A fixing device for a storage box of a low-speed electric vehicle; wherein the storage box is configured to be arranged on a rear end of the low-speed electric vehicle;
the fixing device comprises a rotary seat detachably connected to the storage box, and a mounting portion is concavely formed on the low-speed electric vehicle; the rotary seat is configured to be rotatably assembled in the mounting portion; a mounting surface of the rotary seat is arranged with a convex rib, the convex rib being arranged with a clamping block, and a mounting gap is defined between a part of the clamping block and the convex rib; a resisting piece is convexly formed on the mounting portion, and the clamping block is clamped with or separated from the resisting piece when rotating with the rotary seat.

2. The fixing device according to claim 1, wherein a thickness of the resisting piece is equal to or less than a thickness of the mounting gap.

3. The fixing device according to claim 1, wherein the convex rib comprises two convex ribs, and a positive projection of the two convex ribs in a plane where the rotary seat is located is in a shape of a Taiji; the resisting piece comprises two resisting pieces, and the two resisting pieces are symmetrically arranged on an inner wall of the mounting portion.

4. The fixing device according to claim 3, wherein the clamping block comprises two clamping blocks, and each of the two clamping blocks is disposed at an end of a corresponding convex rib; each clamping block is in a curved structure.

5. The fixing device according to claim 4, wherein a column is convexly formed on a middle part of the mounting portion, and the column has a sliding surface; the column is capable of cooperating with a rotation movement of the clamping block when the clamping block rotates with the rotary seat.

6. The fixing device according to claim 1, wherein an operating surface of the rotary seat defines a countersunk hole, and a rotation block is arranged in the countersunk hole.

7. The fixing device according to claim 6, wherein the rotation block is S-shaped.

8. The fixing device according to claim 1, wherein the fixing device further comprises a fixing seat; the fixing seat is arranged on the low-speed electric vehicle and coaxially disposed with the rotary seat, and a connecting mechanism is arranged between the fixing seat and the rotary seat.

9. The fixing device according to claim 8, wherein the connecting mechanism comprises a bump arranged on the rotary seat and a clamping slot defined on the fixing seat.
